(19) United States
(12) Patent Application Publication
(10) Pub. No.: US 2024/0344843 A1
(43) Pub. Date: Oct. 17, 2024

(54) NAVIGATION DEVICE

(71) Applicant: SUBARU CORPORATION, Tokyo (JP)

(72) Inventor: Akihiro NAKATSURA, Tokyo (JP)

(21) Appl. No.: 18/625,074

(22) Filed: Apr. 2, 2024

(30) Foreign Application Priority Data
Apr. 14, 2023 (JP) 2023-066046

(51) Int. Cl. G01C 21/36; G01C 21/34

(52) U.S. Cl. CPC G01C 21/3691; G01C 21/3461

(57) ABSTRACT

A navigation device includes a current position obtainer, an emergency alarm determiner, a disaster information obtainer, a guidance route calculator, and a display. The current position obtainer acquires a vehicle current position. The emergency alarm determiner determines whether an emergency alarm has been issued. The disaster information obtainer acquires disaster information including at least risky area information when the emergency alarm determiner determines that the emergency alarm has been issued. The guidance route calculator calculates, based on the disaster information, a guidance route to a destination avoiding the risky area. The display displays information on the guidance route calculated by the guidance route calculator. The guidance route calculator calculates the guidance route by setting an evacuation site registered in advance by a user as the destination when: the emergency alarm determiner determines that the emergency alarm has been issued; and the destination has not been set.

### CROSS-REFERENCE TO RELATED APPLICATIONS

The present application claims priority from Japanese Patent Application No. 2023-066046 filed on Apr. 14, 2023, the entire contents of which are hereby incorporated by reference.

### BACKGROUND

The disclosure relates to a navigation device.

In recent years, a navigation device has been proposed that acquires data on an emergency alarm such as an alarm about an earthquake or a heavy rain, and provides a guidance route to a user that allows the user to travel without anxiety.

For example, Japanese Unexamined Patent Application Publication (JP-A) No. 2011-80815 discloses a technique that, when it is detected that an emergency alarm has been issued, acquires data on a risky area related to the emergency alarm and indicates a guidance route to a destination that avoids the risky area to a user.

### SUMMARY

An aspect of the disclosure provides a navigation device configured to be applied to a vehicle. The navigation device includes a current position obtainer, an emergency alarm determiner, a disaster information obtainer, a guidance route calculator, and a display. The current position obtainer is configured to acquire a current position of the vehicle. The emergency alarm determiner is configured to determine whether an emergency alarm has been issued. The disaster information obtainer is configured to acquire disaster information including at least information on a risky area when the emergency alarm determiner determines that the emergency alarm has been issued. The guidance route calculator is configured to calculate, based on the disaster information, a guidance route from the current position to a destination that avoids the risky area. The display is configured to display information on the guidance route calculated by the guidance route calculator. The guidance route calculator is configured to calculate the guidance route by setting an evacuation site registered in advance by a user as the destination when: the emergency alarm determiner determines that the emergency alarm has been issued; and the destination has not been set.

An aspect of the disclosure provides a navigation device configured to be applied to a vehicle. The navigation device includes one or more processors, one or more memories, and a display. The one or more memories are communicably coupled to the one or more processors. The display is configured to display information on a guidance route. The one or more processors are configured to acquire a current position of the vehicle, determine whether an emergency alarm has been issued, acquire disaster information including at least information on a risky area when the emergency alarm has been determined as being issued, calculate, based on the disaster information, the guidance route from the current position to a destination that avoids the risky area, and calculate the guidance route by setting an evacuation site registered in advance by a user as the destination when: the emergency alarm has been determined as being issued; and the destination has not been set.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to describe the principles of the disclosure.

FIG. 1 is a diagram illustrating a configuration of a navigation device according to one example embodiment of the disclosure.

FIG. 2 is a diagram illustrating details of disaster information acquired by a disaster information obtainer of the navigation device illustrated in FIG. 1.

FIG. 3 is a flowchart illustrating a process to be executed by the navigation device illustrated in FIG. 1.

FIG. 4 is a diagram illustrating a configuration of a navigation device according to one example embodiment of the disclosure.

FIG. 5 is a flowchart illustrating a process to be executed by the navigation device illustrated in FIG. 4.

### DETAILED DESCRIPTION

In a technique described in JP-A No. 2011-80815, when a destination has not been set, it is determined whether a road on which a vehicle is traveling enters a risky area. A user is simply alerted based on a result of the determination. This hinders the user from driving without anxiety.

It is desirable to provide a navigation device that indicates a guidance route that avoids a risky area to a user even when a destination has not been set.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

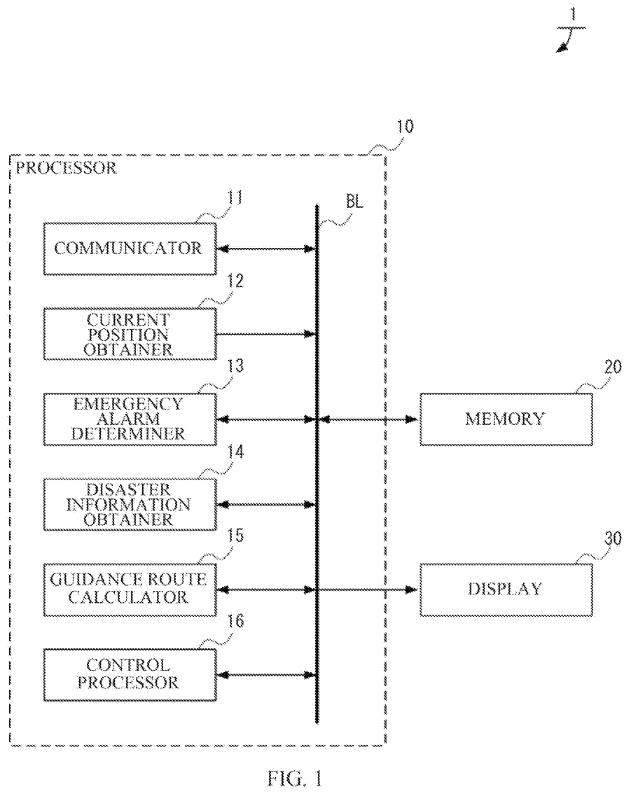

A navigation device according to example embodiments will be described with reference to FIGS. 1 to 5.

### First Example Embodiment

A navigation device 1 according to a first example embodiment will now be described with reference to FIGS. 1 to 3.

### <Configuration of Navigation Device 1>

As illustrated in FIG. 1, the navigation device 1 according to the first example embodiment may include a processor 10, a memory 20, and a display 30.

Note that the processor 10 will be described later.

The memory 20 may include, for example, a read-only memory (ROM) and a random-access memory (RAM). The ROM may store, for example, a control program and map information. The RAM may store, for example, various kinds of data received from the processor 10.

The display 30 may be any display such as a liquid crystal panel or an organic EL panel, and display information on a guidance route received from the processor 10. In one embodiment, the display 30 may serve as a “display”.

### <Configuration of Processor 10>

The processor 10 may include a communicator 11, a current position obtainer 12, an emergency alarm determiner 13, a disaster information obtainer 14, a guidance route calculator 15, and a control processor 16.

The components of the processor 10 and the memory 20 may transmit and receive various kinds of data through a bus line BL.

The communicator 11 may be, for example, a wireless communication module that is couplable to an Internet network. The communicator 11 may serve as an interface used to acquire data from a server coupled to the Internet network.

The current position obtainer 12 acquires current position information of a vehicle.

The current position obtainer 12 may acquire the current position information of the vehicle equipped with the navigation device 1, based on electric waves received from a global positioning system (GPS).

The current position obtainer 12 may store the acquired current position information of the vehicle in the memory 20 through the bus line BL. In one embodiment, the current position obtainer 12 may serve as a “current position obtainer”.

The emergency alarm determiner 13 determines whether an emergency alarm has been issued.

The emergency alarm determiner 13 may be coupled to a non-illustrated server in which data on the emergency alarm is stored, through the communicator 11, and determine whether the emergency alarm has been issued.

The above-described emergency alarm may be information that alerts, for example, local residents when there is a risk of an occurrence of, for example, a serious disaster. Non-limiting examples of the emergency alarm may include a heavy rain alarm, a flood alarm, a storm alarm, a tsunami alarm, and an eruption alarm.

The emergency alarm determiner 13 may transmit a result of the determination to the disaster information obtainer 14, the guidance route calculator 15, and the control processor 16, which will be described later, through the bus line BL. In one embodiment, the emergency alarm determiner 13 may serve as an “emergency alarm determiner”.

When the emergency alarm determiner 13 determines that the emergency alarm has been issued, the disaster information obtainer 14 acquires disaster information including at least information on a risky area.

When the emergency alarm determiner 13 determines that the emergency alarm has been issued, the disaster information obtainer 14 may be coupled to a non-illustrated server in which data on the disaster information is stored, through the communicator 11, and acquire the disaster information.

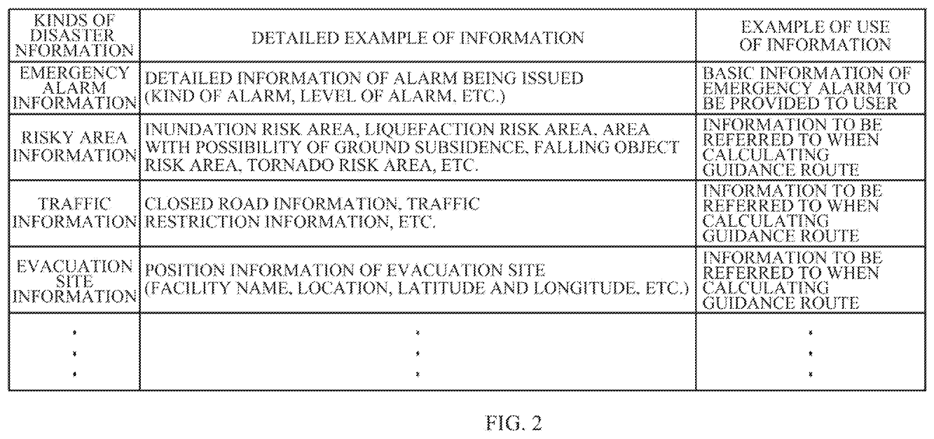

For example, as illustrated in FIG. 2, the disaster information obtainer 14 may acquire information such as emergency alarm information, risky area information, traffic information, or evacuation site information as the disaster information.

The emergency alarm information may be detailed information of the emergency alarm being issued. Non-limiting examples of the detailed information may include a kind of an alarm and a level of an alarm.

The risky area information may be information indicating an area that is risky for the vehicle to travel. Non-limiting examples of the area that is risky for the vehicle to travel may include an inundation risk area, a liquefaction risk area, an area with a possibility of ground subsidence, a falling object risk area, and a tornado risk area.

The traffic information may be, for example, regulation information on vehicle traffic associated with an alarm that has been issued. Non-limiting examples of the regulation information may include closed road information and traffic restriction information.

The evacuation site information may be information on a place where it is possible to take shelter when, for example, a disaster occurs. Non-limiting examples of the evacuation site information may include information such as a facility name, a location, and a latitude and a longitude of the evacuation site.

The disaster information obtainer 14 may store the acquired disaster information in the memory 20 through the bus line BL. In one embodiment, the disaster information obtainer 14 may serve as a “disaster information obtainer”.

The guidance route calculator 15 calculates the guidance route from a current position to a destination that avoids the risky area, based on the disaster information.

When the emergency alarm determiner 13 determines that the emergency alarm has been issued, and the control processor 16, which will be described later, determines that the destination has not been set, the guidance route calculator 15 calculates the guidance route by setting a registered evacuation site registered in advance by a user as the destination.

The above-described registered evacuation site may be an evacuation site at which the user is to take shelter when a disaster occurs. The user may operate, for example, a non-illustrated input unit of the navigation device 1 to register information on the registered evacuation site, such as the facility name and the location, in advance in the navigation device 1.

Note that the information on the registered evacuation site registered by the user may be stored in the memory 20.

The guidance route calculator 15 may refer to the map information, the information on the registered evacuation site, the current position information, and the disaster information, such as the risky area information and the traffic information, stored in the memory 20, and calculate the guidance route from the current position to the registered evacuation site that avoids the risky area.

The guidance route calculator 15 may store a result of the calculation in the memory 20 through the bus line BL.

Note that the guidance route calculator 15 may transmit, to the control processor 16, which will be described later, data indicating that it is difficult to calculate the guidance route when it is difficult to calculate a safe guidance route from the current position to the registered evacuation site that avoids the risky area due to, for example, a closed road or a traffic regulation.

When the emergency alarm determiner 13 determines that the emergency alarm has been issued, and the control processor 16, which will be described later, determines that the destination has been set, the guidance route calculator 15 may calculate the guidance route to the destination that avoids the risky area, and store a result of the calculation in the memory 20 through the bus line BL.

When it is difficult to calculate the guidance route that avoids the risky area, the guidance route calculator 15 may calculate the guidance route by setting the evacuation site closest to the current position as the destination.

When it is difficult to calculate the guidance route that avoids the risky area, the guidance route calculator 15 may refer to the evacuation site information, such as the facility name, the location, and the latitude and the longitude, acquired by the disaster information obtainer 14 in accordance with an instruction of the control processor 16, which will be described later, and calculate the guidance route with the destination set to the evacuation site closest to the current position.

The guidance route calculator 15 may store a result of the calculation in the memory 20 through the bus line BL. In one embodiment, the guidance route calculator 15 may serve as a “guidance route calculator”.

The control processor 16 may control an overall operation of the navigation device 1 in accordance with a control program stored in the memory 20.

In the first example embodiment, for example, when it is difficult for the guidance route calculator 15 to calculate the guidance route from the current position to the registered evacuation site that avoids the risky area, the control processor 16 may perform control to cause the guidance route calculator 15 to calculate the guidance route with the destination set to the evacuation site closest to the current position.

For example, upon receipt of the data indicating that it is difficult to calculate the guidance route from the guidance route calculator 15, the control processor 16 may transmit, to the guidance route calculator 15, an instruction to calculate the guidance route with the destination set to the evacuation site closest to the current position.

Further, for example, the control processor 16 may change a display mode in accordance with the guidance route calculated by the guidance route calculator 15, and cause the display 30 to display information on the guidance route.

When the control processor 16 causes the information on the guidance route with the destination set to the registered evacuation site to be displayed, the control processor 16 may cause the display 30 to display the guidance route and, for example, the following text information: “Currently, a heavy rain special alarm is issued. There is a risky area for the vehicle to travel. A safe guidance route to the registered evacuation site is displayed avoiding the risky area.”

Additionally, when the control processor 16 causes the information on the guidance route with the destination set to the evacuation site closest to the current position to be displayed, the control processor 16 may cause the display 30 to display the guidance route and, for example, the following text information: “Currently, a heavy rain special alarm is issued. It is difficult to indicate a safe guidance route to the registered evacuation site due to a vehicle traffic regulation. A guidance route to the evacuation site at a distance closest to the current position is displayed.”

### <Process to be Executed by Navigation Device 1>

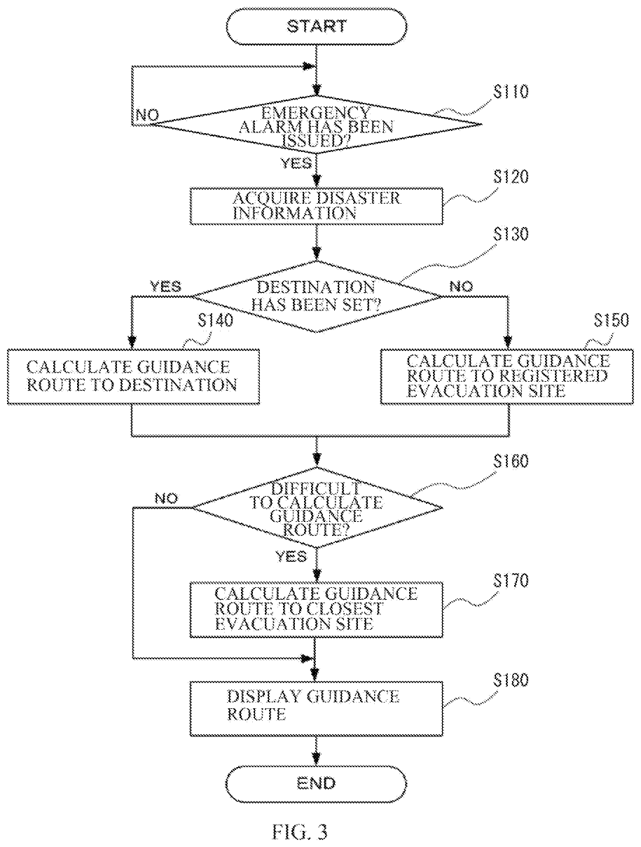

A process to be executed by the navigation device 1 will be described with reference to FIG. 3.

The emergency alarm determiner 13 determines whether the emergency alarm has been issued (step S110).

When the emergency alarm determiner 13 determines that the emergency alarm has not been issued (“NO” in step S110), the emergency alarm determiner 13 may cause the process to return and shift to a standby mode.

In contrast, when the emergency alarm determiner 13 determines that the emergency alarm has been issued (“YES” in step S110), the disaster information obtainer 14 may acquire the disaster information from the server (step S120) and cause the process to shift to step S130.

The control processor 16 may determine whether the destination has been set (step S130).

When the control processor 16 determines that the destination has been set (“YES” in step S130), the guidance route calculator 15 may calculate the guidance route to the destination set by the user, based on the disaster information (step S140).

In contrast, when the control processor 16 determines that the destination has not been set (“NO” in step S130), the guidance route calculator 15 may calculate the guidance route to the registered evacuation site registered by the user, based on the disaster information (step S150).

The control processor 16 may determine whether the data indicating that it is difficult to calculate the guidance route that avoids the risky area has been received from the guidance route calculator 15 (step S160).

When the control processor 16 determines that the data indicating that it is difficult to calculate the guidance route that avoids the risky area has not been received from the guidance route calculator 15 (“NO” in step S160), the control processor 16 may cause the process to shift to step S180.

In contrast, when the control processor 16 determines that the data indicating that it is difficult to calculate the guidance route that avoids the risky area has been received from the guidance route calculator 15 (“YES” in step S160), the control processor 16 may transmit, to the guidance route calculator 15, an instruction to calculate the guidance route with the destination set to the evacuation site closest to the current position to cause the guidance route calculator 15 to calculate the guidance route (step S170).

The control processor 16 may cause the display 30 to display information on the guidance route calculated by the guidance route calculator 15 (step S180), and end the process.

### Workings and Example Effects

As described above, the navigation device 1 according to the first example embodiment includes the current position obtainer 12, the emergency alarm determiner 13, the disaster information obtainer 14, the guidance route calculator 15, and the display 30. The current position obtainer 12 acquires the current position of the vehicle. The emergency alarm determiner 13 determines whether the emergency alarm has been issued. The disaster information obtainer 14 acquires disaster information including at least information on a risky area when the emergency alarm determiner 13 determines that the emergency alarm has been issued. The guidance route calculator 15 calculates a guidance route from the current position to the destination that avoids the risky area, based on the disaster information. The display 30 displays information on the calculated guidance route.

When the emergency alarm determiner 13 determines that the emergency alarm has been issued, and the destination has not been set, the guidance route calculator 15 calculates the guidance route by setting the registered evacuation site registered in advance by the user as the destination.

For example, even if the vehicle is traveling without the destination being set, when the emergency alarm is detected, the navigation device 1 may calculate the guidance route to the registered evacuation site that avoids the risky area, based on the disaster information, and indicate information on the calculated guidance route to the user.

This helps the user to drive without anxiety even when the user is traveling without setting the destination because the information on the guidance route that avoids the risky area is indicated.

Additionally, the user may not be guided to an unknown place where the user has never visited before, but may be guided to the evacuation site registered by the user. This helps the user to drive without anxiety.

Further, it is possible for the navigation device 1 to cause the user to recognize that the emergency alarm has been issued by displaying the information on the guidance route. This helps to alert the user.

In some embodiments, when it is difficult to calculate the guidance route that avoids the risky area, the guidance route calculator 15 of the navigation device 1 according to the first example embodiment may set the evacuation site closest to the current position as the destination, and calculate the guidance route.

For example, when it is difficult to calculate a safe guidance route that avoids the risky area, the navigation device 1 may indicate, to the user, information on the guidance route to the evacuation site closest to the current position to secure safety of the user.

Accordingly, even when the user is traveling without setting the destination, the user may be guided to a safe place closest to the current position. This helps the user to drive without anxiety.

### Second Example Embodiment

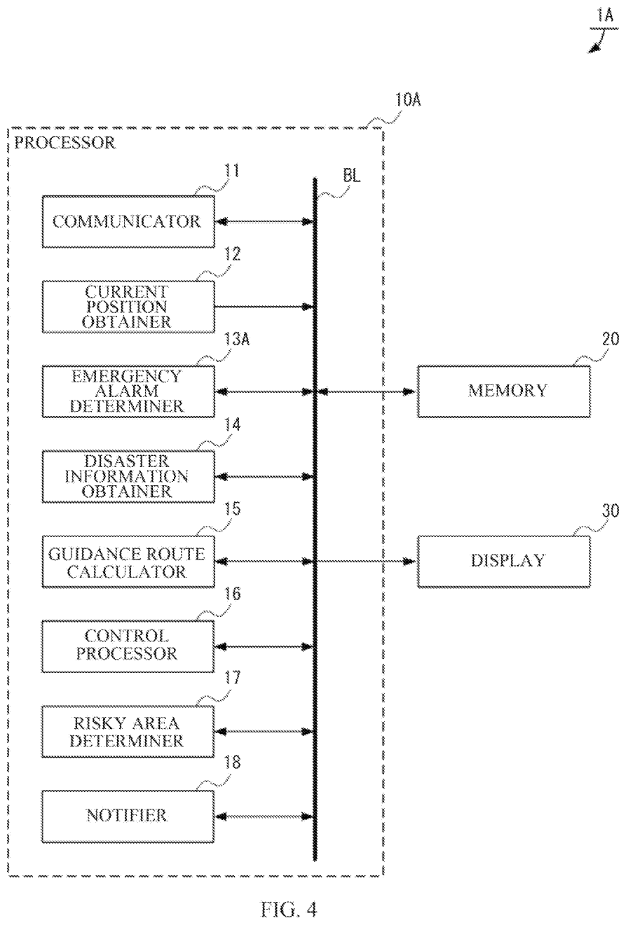

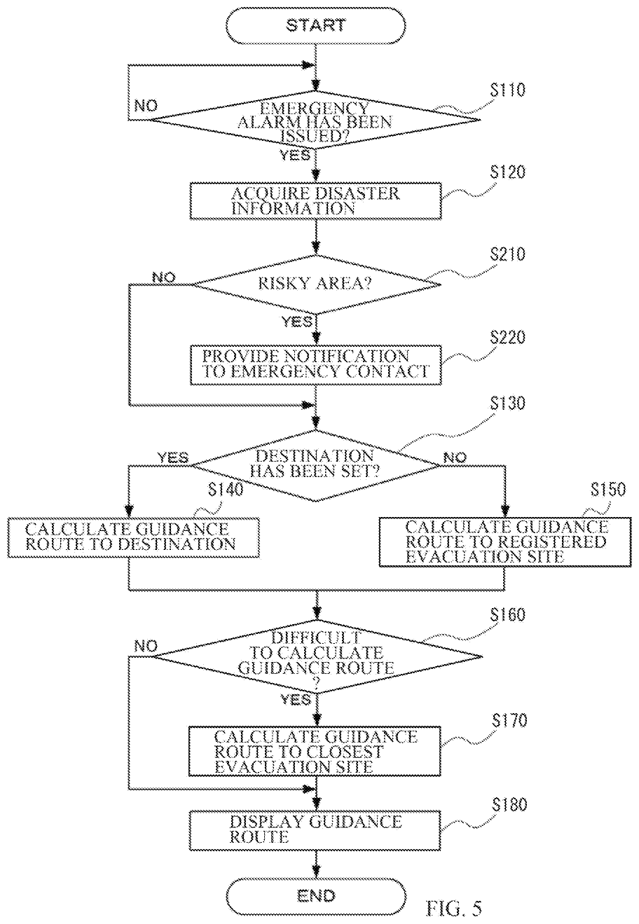

A navigation device 1A according to a second example embodiment will be described with reference to FIGS. 4 to 5.

Components denoted with the same reference numerals as those in the first example embodiment have similar functions, and detailed descriptions thereof will be omitted.

### <Configuration of Navigation Device 1A>

As illustrated in FIG. 4, the navigation device 1A according to the second example embodiment may include a processor 10A, the memory 20, and the display 30.

### <Configuration of Processor 10A>

The processor 10A may include the communicator 11, the current position obtainer 12, an emergency alarm determiner 13A, the disaster information obtainer 14, the guidance route calculator 15, the control processor 16, a risky area determiner 17, and a notifier 18.

The emergency alarm determiner 13A may determine whether the emergency alarm has been issued.

The emergency alarm determiner 13A may be coupled to a non-illustrated server in which data on the emergency alarm is stored, through the communicator 11, determine whether the emergency alarm has been issued, and transmit a result of the determination to the disaster information obtainer 14, the guidance route calculator 15, the control processor 16, and the risky area determiner 17, which will be described later.

When the emergency alarm determiner 13A determines that the emergency alarm has been issued, the risky area determiner 17 may determine whether the current position of the vehicle is in the risky area.

The risky area determiner 17 may determine whether the current position of the vehicle is in the risky area, based on the current position information of the vehicle and the disaster information, such as the risky area information, stored in the memory 20, and transmit a result of the determination to the notifier 18, which will be described later, through the bus line BL.

When the risky area determiner 17 determines that the current position of the vehicle is in the risky area, the notifier 18 may notify an emergency contact registered in advance of information indicating that the vehicle is present in the risky area.

The above-described emergency contact may be contact information of a person to whom the user wants to tell that the user is traveling in a risky area. The user may operate a non-illustrated input unit to register in advance information on the emergency contact, such as a mail address, in the navigation device 1A.

Note that the information on the emergency contact inputted by the user may be stored in the memory 20.

When the notifier 18 receives, from the risky area determiner 17, the result of the determination indicating that the current position of the vehicle is in the risky area, the notifier 18 may notify the emergency contact of, for example, the disaster information, such as the emergency alarm information and the risky area information, and the current position information of the vehicle, through the communicator 11. In one embodiment, the risky area determiner 17 may serve as a “risky area determiner”, and the notifier 18 may serve as a “notifier”.

### <Process to be Executed by Navigation Device 1A>

A process to be executed by the navigation device 1A will be described with reference to FIG. 5.

The emergency alarm determiner 13A may determine whether the emergency alarm has been issued (step S110).

When the emergency alarm determiner 13A determines that the emergency alarm has not been issued (“NO” in step S110), the emergency alarm determiner 13A may cause the process to return and shift to a standby mode.

In contrast, when the emergency alarm determiner 13A determines that the emergency alarm has been issued (“YES” in step S110), the disaster information obtainer 14 may acquire the disaster information from the server (step S120) and cause the process to shift to step S210.

The risky area determiner 17 may determine whether the current position of the vehicle is in the risky area (step S210).

When determining that the current position of the vehicle is not in the risky area (“NO” in step S210), the risky area determiner 17 may cause the process to shift to step S130.

In contrast, when the risky area determiner 17 determines that the current position of the vehicle is in the risky area (“YES” in step S210), the notifier 18 may notify the emergency contact of information indicating that the vehicle is present in the risky area (step S220).

The control processor 16 may determine whether the destination has been set (step S130).

When the control processor 16 determines that the destination has been set (“YES” in step S130), the guidance route calculator 15 may calculate the guidance route to the destination set by the user, based on the disaster information (step S140).

In contrast, when the control processor 16 determines that the destination has not been set (“NO” in step S130), the guidance route calculator 15 may calculate the guidance route to the registered evacuation site registered by the user, based on the disaster information (step S150).

The control processor 16 may determine whether the data indicating that it is difficult to calculate the guidance route that avoids the risky area has been received from the guidance route calculator 15 (step S160).

When the control processor 16 determines that the data indicating that it is difficult to calculate the guidance route that avoids the risky area has not been received from the guidance route calculator 15 (“NO” in step S160), the control processor 16 may cause the process to shift to step S180.

In contrast, when the control processor 16 determines that the data indicating that it is difficult to calculate the guidance route that avoids the risky area has been received from the guidance route calculator 15 (“YES” in step S160), the control processor 16 may transmit, to the guidance route calculator 15, an instruction to calculate the guidance route with the destination set to the evacuation site closest to the current position to cause the guidance route calculator 15 to calculate the guidance route (step S170).

The control processor 16 may cause the display 30 to display information on the guidance route calculated by the guidance route calculator 15 (step S180), and end the process.

### Workings and Example Effects

As described above, the navigation device 1A according to the second example embodiment may include the risky area determiner 17 and the notifier 18. The risky area determiner 17 may determine whether the current position of the vehicle is in the risky area when the emergency alarm determiner 13A determines that the emergency alarm has been issued. The notifier 18 may notify an emergency contact registered in advance of information indicating that the vehicle is present in the risky area when the risky area determiner 17 determines that the current position of the vehicle is in the risky area.

As a result, the emergency contact may be automatically notified of information indicating that the vehicle is traveling in the risky area in which the emergency alarm has been issued. This helps the user to concentrate on driving.

Further, the emergency contact may be notified of information including, for example, the disaster information, such as the emergency alarm information and the risky area information, and the current position information of the vehicle. This helps the person who has received the notification to accurately grasp a situation of the user.

### Modification Example 1

The navigation device 1A according to the second example embodiment described above may notify the emergency contact of the information indicating that the vehicle is present in the risky area when the emergency alarm determiner 13A determines that the emergency alarm has been issued. In some embodiments, the navigation device 1A may further notify the emergency contact again of information indicating that the vehicle is present outside the risky area when the vehicle moves out of the risky area.

This helps the person who has received the notification to check the safety of the user.

### Modification Example 2

The navigation device 1A according to the second example embodiment described above may notify the emergency contact of the information indicating that the vehicle is present in the risky area when the emergency alarm determiner 13A determines that the emergency alarm has been issued. In some embodiments, the navigation device 1A may further notify the emergency contact of, for example, safety information inputted by the user or a voice message.

This helps the user to more accurately transmit the situation of the user himself or herself who is traveling in the risky area to the person registered as the emergency contact.

In some embodiments, it is possible to implement the navigation device 1 of the example embodiment of the disclosure by recording the process to be executed by the emergency alarm determiner 13, the guidance route calculator 15, and the control processor 16 on a non-transitory recording medium readable by a computer system, and causing the computer system to load the program recorded on the non-transitory recording medium onto the emergency alarm determiner 13, the guidance route calculator 15, and the control processor 16 to execute the program.

The computer system as used herein may encompass an operating system (OS) and a hardware such as a peripheral device.

In addition, when the computer system utilizes a World Wide Web (WWW) system, the “computer system” may encompass a website providing environment (or a website displaying environment).

The program may be transmitted from a computer system that contains the program in a storage device or the like to another computer system via a transmission medium or by a carrier wave in a transmission medium.

The “transmission medium” that transmits the program may refer to a medium having a capability to transmit data, including a network (e.g., a communication network) such as the Internet and a communication link (e.g., a communication line) such as a telephone line.

Further, the program may be directed to implement a part of the operation described above.

The program may be a so-called differential file (differential program) configured to implement the operation by a combination of a program already recorded on the computer system.

Although some example embodiments and modification examples of the disclosure have been described in the foregoing by way of example with reference to the accompanying drawings, the disclosure is by no means limited to the example embodiments and modification examples described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

In at least one embodiment of the disclosure, it is possible to indicate a guidance route that avoids a risky area to a user even when a destination has not been set.

Each of the current position obtainer 12, the emergency alarm determiner 13, the disaster information obtainer 14, and the guidance route calculator 15 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of each of the current position obtainer 12, the emergency alarm determiner 13, the disaster information obtainer 14, and the guidance route calculator 15. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of each of the current position obtainer 12, the emergency alarm determiner 13, the disaster information obtainer 14, and the guidance route calculator 15 illustrated in FIG. 1.

1. A navigation device configured to be applied to a vehicle, the navigation device comprising:
a current position obtainer configured to acquire a current position of the vehicle;
an emergency alarm determiner configured to determine whether an emergency alarm has been issued;
a disaster information obtainer configured to acquire disaster information comprising at least information on a risky area when the emergency alarm determiner determines that the emergency alarm has been issued;
a guidance route calculator configured to calculate, based on the disaster information, a guidance route from the current position to a destination that avoids the risky area; and
a display configured to display information on the guidance route calculated by the guidance route calculator, wherein
the guidance route calculator is configured to calculate the guidance route by setting an evacuation site registered in advance by a user as the destination when: the emergency alarm determiner determines that the emergency alarm has been issued; and the destination has not been set.

2. The navigation device according to claim 1, wherein, the guidance route calculator is configured to, when the guidance route calculator involves difficulty in calculating the guidance route that avoids the risky area, calculate the guidance route by setting an evacuation site closest to the current position as the destination.

3. The navigation device according to claim 1, further comprising:
a risky area determiner configured to determine whether the current position of the vehicle is in the risky area when the emergency alarm determiner determines that the emergency alarm has been issued; and
a notifier configured to notify an emergency contact registered in advance of information indicating that the vehicle is present in the risky area when the risky area determiner determines that the current position of the vehicle is in the risky area.

4. The navigation device according to claim 2, further comprising:
a risky area determiner configured to determine whether the current position of the vehicle is in the risky area when the emergency alarm determiner determines that the emergency alarm has been issued; and
a notifier configured to notify an emergency contact registered in advance of information indicating that the vehicle is present in the risky area when the risky area determiner determines that the current position of the vehicle is in the risky area.

5. A navigation device configured to be applied to a vehicle, the navigation device comprising:
one or more processors;
one or more memories communicably coupled to the one or more processors; and
a display configured to display information on a guidance route, wherein
the one or more processors are configured to
acquire a current position of the vehicle,
determine whether an emergency alarm has been issued,
acquire disaster information comprising at least information on a risky area when the emergency alarm has been determined as being issued,
calculate, based on the disaster information, the guidance route from the current position to a destination that avoids the risky area, and
calculate the guidance route by setting an evacuation site registered in advance by a user as the destination when: the emergency alarm has been determined as being issued; and the destination has not been set.
